(19) United States
(12) Patent Application Publication
(10) Pub. No.: US 2009/0107765 A1
(43) Pub. Date: Apr. 30, 2009

(54) Extension ladder stabilizer

(76) Inventor: Clyde Germond, Roseburg, OR (US)

Correspondence Address: LAW OFFICE OF GERALD D. HAYNES, 2 NORTH OAKDALE AVENUE, MEDFORD, OR, 97501, US

(21) Appl. No.: 11/980,258

(22) Filed: Oct. 30, 2007

(51) Int. Cl. E06C 1/00

(52) U.S. Cl. 182/172

(57) ABSTRACT

An extension ladder stabilizer includes a pair of generally elongated, spaced-apart ladder mount members; a pair of generally elongated stabilizer legs swivelly carried by the pair of ladder mount members, respectively; a pair of leg braces having a pair of leg receptacles, respectively, swivelly carried by the pair of ladder mount members, respectively. In a functional or ladder-stabilizing configuration of the extension ladder stabilizer, the pair of ladder mount members is adapted to receive the pair of stabilizer legs which in turn engage the ground or floor and the pair of leg receptacles is adapted to removably receive the pair of stabilizer legs, respectively. A stabilized extension ladder is also disclosed.

### FIELD

The present disclosure relates to ladders. More particularly, the present disclosure relates to an extension ladder stabilizer which stabilizes an extension ladder in an upright position.

### BACKGROUND

Extension ladders are commonly used to reach elevated areas on a wall or ceiling for repair, painting or access purposes, for example. A typical conventional extension ladder includes a frame having a pair of elongated, spaced-apart, parallel ladder frame members. Multiple, spaced-apart rungs connect the ladder frame members. The rungs serve as steps for a user as the ladder frame members are placed on a floor or the ground and leaned against a wall or other support. One of the drawbacks of extension ladders, however, is their instability and tendency to lean or fall over in the event that a user on the ladder reaches to one side of the ladder or when the user stands on the floor or ground and initially grasps the ladder to begin climbing.

### SUMMARY

The present disclosure is generally directed to an extension ladder stabilizer includes a pair of generally elongated, spaced-apart ladder mount members; a pair of generally elongated stabilizer legs swivelly carried by the pair of ladder mount members, respectively; a pair of leg braces having a pair of leg receptacles, respectively, swivelly carried by the pair of ladder mount members, respectively. In a functional or ladder-stabilizing configuration of the extension ladder stabilizer, the pair of ladder mount members is adapted to receive the pair of stabilizer legs which in turn engage the ground or floor and the pair of leg receptacles is adapted to removably receive the pair of stabilizer legs, respectively.

The present disclosure is further generally directed to a stabilized extension ladder. An illustrative embodiment of the stabilized extension ladder includes an extension ladder having a pair of spaced-apart ladder frame members and a plurality of ladder rungs connecting the pair of ladder frame members. An extension ladder stabilizer includes a pair of generally elongated, spaced-apart ladder mount members carried by the extension ladder; a pair of generally elongated stabilizer legs swivelly carried by the pair of ladder mount members, respectively; and a pair of leg braces having a pair of leg receptacles, respectively, swivelly carried by the pair of ladder mount members, respectively. In a functional or ladder-stabilizing configuration of the extension ladder stabilizer, the pair of ladder mount members is adapted to receive the pair of stabilizer legs which in turn engage the ground or floor and the pair of leg receptacles is adapted to removably receive the pair of stabilizer legs, respectively.

### BRIEF DESCRIPTION OF THE DRAWINGS

FIG. 1 is a front view of an illustrative embodiment of the extension ladder stabilizer, fitted on an extension ladder (shown in phantom) and illustrated in a non-functional or storage position;

FIG. 2 is a front view of an illustrative embodiment of the extension ladder stabilizer, fitted on an extension ladder (shown in phantom) and illustrated in a functional, ladder-stabilizing position;

FIG. 3 is a side view of an illustrative swivel bracket which is suitable for attachment of a stabilizer leg (partially in section) to a ladder mount member (partially in section) of the extension ladder stabilizer;

FIG. 4 is a side view with a 90° rotation of an illustrative swivel bracket which is suitable for attachment of the stabilizer leg (partially in section) to the ladder mount member (partially in section) of the extension ladder stabilizer;

FIG. 5 is a side view of an illustrative embodiment of the extension ladder stabilizer, fitted on an extension ladder (shown in phantom) leaning against a wall and with the extension ladder stabilizer illustrated in a non-functional or storage position;

FIG. 6 is a side view of an illustrative embodiment of the extension ladder stabilizer, fitted on an extension ladder (shown in phantom) leaning against a wall and with the extension ladder stabilizer illustrated in a functional, ladder-stabilizing position;

FIG. 7 is a side view of a leg brace (partially in section) and a leg receptacle provided on the leg brace, with a stabilizer leg (shown in cross-section) seated in a leg receptacle cavity provided in the leg receptacle when the extension ladder stabilizer is disposed in the functional, ladder-stabilizing position;

FIG. 8 is a side view of an attachment device which is suitable for attachment of the extension ladder stabilizer to a ladder; and

FIG. 9 illustrates typical attachment of the extension ladder stabilizer to an extension ladder using the attachment device shown in FIG. 8.

### DETAILED DESCRIPTION

Referring to the drawings, an illustrative embodiment of the extension ladder stabilizer is generally indicated by reference numeral 1. As illustrated in FIGS. 1, 2, 5 and 6 and will be hereinafter described, the extension ladder stabilizer 1 is fitted on an extension ladder 30 typically in a manner which will be hereinafter described. The extension ladder stabilizer 1 imparts structural stability to the extension ladder 30 as the extension ladder 30 leans against a wall 37 or other upright surface and as a user (not illustrated) ascends, stands on and descends the extension ladder 30. The extension ladder stabilizer 1 prevents or reduces the likelihood that the extension ladder 30 will shift from side-to-side or backwards as the user ascends and descends the extension ladder 30 and reaches to the left or right of the extension ladder 30. This renders the extension ladder 30 safer to use. The extension ladder 30 may be conventional and typically includes a pair of generally elongated, parallel, spaced-apart ladder frame members 31 and multiple ladder rungs 32 which connect the ladder frame members 31. Ladder feet 33 may be provided on the lower ends of the respective ladder frame members 31. Alternatively, the ladder feet 33 may be omitted from the lower ends of the ladder frame members 31. In some embodiments, stabilizer leg feet (not illustrated) may be provided on the lower ends of the respective ladder stabilizer legs 10. When the extension ladder stabilizer 1 is in the functional, ladder-stabilizing position, the ladder feet 33 are typically suspended.

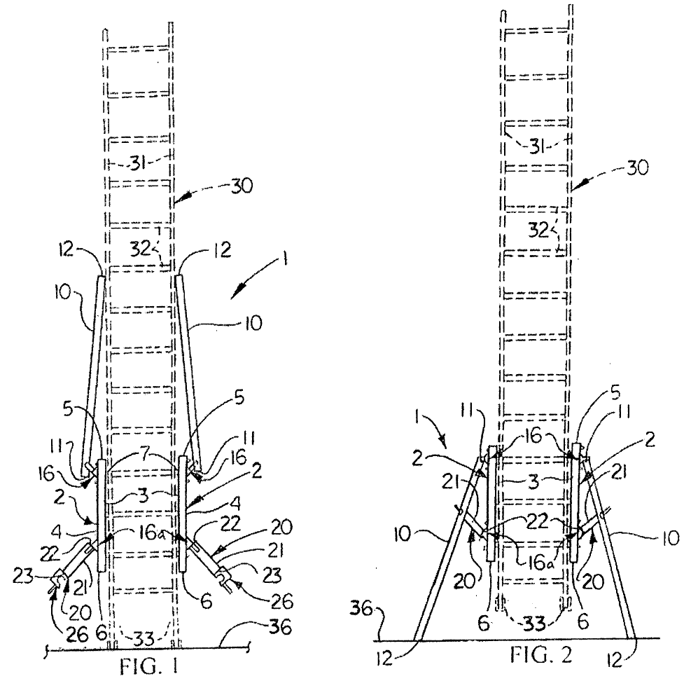

As illustrated in FIGS. 1 and 2, the extension ladder stabilizer 1 includes a pair of generally elongated, spaced-apart, parallel ladder mount members 2 which are attached to the extension ladder 30 typically in a manner which will be hereinafter described. Each ladder mount member 2 may have a generally elongated, rectangular shape and may include an inner surface 3; an outer surface 4; an upper end 5; and a lower end 6. A generally elongated stabilizer leg 10 has a proximal leg end 11 which is swivelly attached to the outer surface 4 of each ladder mount member 2, generally adjacent to the upper end 5 thereof. The stabilizer leg 10 has a distal leg end 12 which is opposite the proximal leg end 11.

A leg brace 20 includes a generally elongated leg brace shaft 21 having a proximal shaft end 22 which is swivelly attached to the outer surface 4 of each ladder mount member 2, generally adjacent to the lower end 6 thereof. The leg brace 20 has a distal shaft end 23 which is opposite the proximal shaft end 22. A leg receptacle 26 is provided on the distal shaft end 23. As illustrated in FIG. 7, the leg receptacle 26 may include a leg receptacle body 27 having a leg receptacle cavity 28 which is adapted to receive the corresponding stabilizer leg 10 when the extension ladder stabilizer 1 is disposed in the functional, ladder-stabilizing configuration.

In some embodiments, a leg clamping mechanism such as a leg gripping member 60 having gripping teeth 61, for example, is pivotally attached to the leg receptacle body 27 via a pivot pin 62. The purpose of the leg gripping member 60 will be hereinafter described.

The stabilizer leg 10 and the leg brace 20 may each be swivelly attached to the outer surface 4 of the corresponding ladder mount member 2 using any suitable technique which is known by those skilled in the art. As illustrated in FIGS. 1 and 2, in some embodiments an upper swivel bracket 16 is provided on the outer surface 4 of the ladder mount member 2, generally adjacent to the upper end 5 thereof. A lower swivel bracket 16a is provided on the outer surface 4 of the ladder mount member 2, generally adjacent to the lower end 6 thereof. The proximal leg end 11 of the stabilizer leg 10 is attached to the upper swivel bracket 16, whereas the proximal shaft end 22 of the leg brace shaft 21 of the leg brace 20 is attached to the lower swivel bracket 16a.

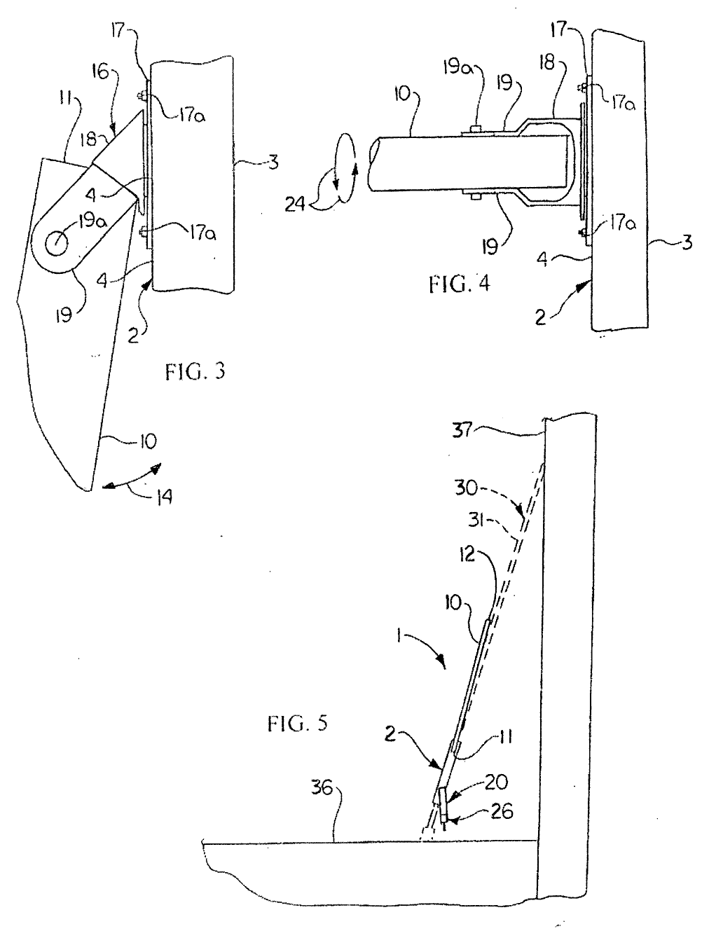

As illustrated in FIGS. 3 and 4, each upper swivel bracket 16 (and each lower swivel bracket 16a) may include a base plate 17. The base plate 17 may be secured to the outer surface 4 of the ladder mount member 2 using fasteners 17a and/or any suitable alternative technique which is known by those skilled in the art. A bracket body 18 is rotatably attached to the base plate 17. A pair of spaced-apart bracket flanges 19 extends from the bracket body 18. The proximal end 11 of the stabilizer leg 10 extends between the bracket flanges 19 of the upper swivel bracket 16. A pivot pin or bolt 19a extends through registering openings (not illustrated) provided in the bracket flanges 19 and the stabilizer leg 10. Likewise, the proximal shaft end 22 of the leg brace shaft 21 of the leg brace 20 is attached to the bracket flanges 19 of the lower swivel bracket 16a. Accordingly, the stabilizer leg 10 is capable of pivoting with respect to the ladder mount member 2, as illustrated by the arrow 14 in FIG. 3, as well as rotating with respect to the ladder mount member 2, as illustrated by the arrow 24 in FIG. 4. In similar manner, the lower swivel bracket 16a facilitates pivoting and rotation of the leg brace shaft 21 of the leg brace 20 with respect to the ladder mount member 2.

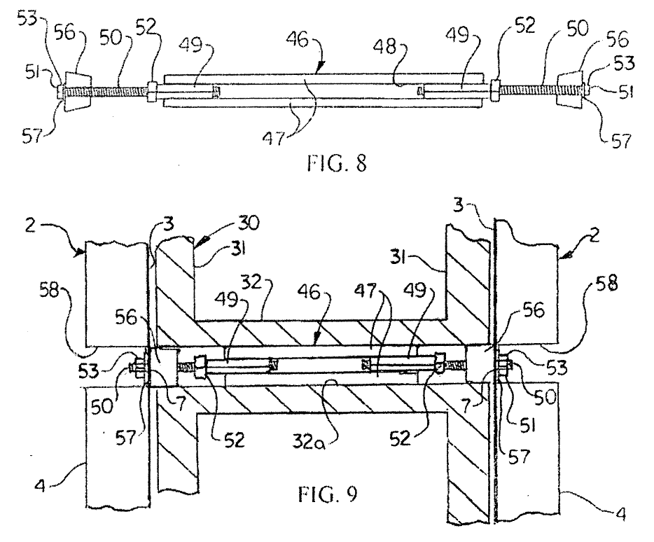

As illustrated in FIGS. 8 and 9, an attachment device 46 which is suitable for attachment of the ladder mount members 2 to each other and to the extension ladder 30 is illustrated. The attachment device 46 includes a pair of generally elongated, parallel, spaced-apart device frame plates 47. A frame plate gap 48 is defined between the device frame plates 47. An end nut 49 is provided in the frame plate gap 48, at each end of the device frame plates 47. The end nut 49 may be welded and/or otherwise attached to the device frame plates 47. An elongated threaded rod 50 having a proximal end 51 is threaded through each end nut 49. A nut 52 is threaded on the threaded rod 50 between each end nut 49 and the proximal end 51. Each nut 52 is tightened against the corresponding elongated end nut 49 so as to allow enough of the threaded rod 50 to protrude into the ladder mount member 2 and accept the thickness of the ladder mount member 2, washer 57 and nut 52. A tapered resilient spacer 56 is provided on each end of the threaded rod 50 and centers the attachment device 46 in the ladder rung 32.

As illustrated in FIG. 9, the ladder mount members 2 may be attached to the extension ladder 30 by extending the device frame plates 47 of the attachment device 46 through a rung bore 32a which extends through each ladder rung 32 of the extension ladder 30. Each threaded rod 50 is extended through a bolt opening 7 which extends through each ladder mount member 2. An installation access opening 58 is provided through the outer surface 4 of the ladder mount member 2 and corresponds with the threaded rod opening 7. The tapered spacer 56 is placed on each threaded rod 50 and is inserted into the rung bore 32a, tapered end first, and abuts against the inner surface 3 of each ladder mount member 2. A nut 53 is threaded on each threaded rod 50 with a washer 57 being interposed between the ladder mount member 2 and the nut 53 on the proximal end 51 of the threaded rod 50. By tightening the nuts 53 on the proximal ends 51 of the threaded rods 50, the inner surfaces 3 of the ladder mount members 2 are secured against the tapered spacers 56.

In typical application, a pair of attachment devices 46 is used to secure the ladder mount members 2 to the extension ladder 30 at the second and third ladder rungs 32, respectively, from the ladder feet 33 of the extension ladder 30. The upper swivel brackets 16 may be attached to the respective ladder mount members 2 either above or below the respective installation access openings 58.

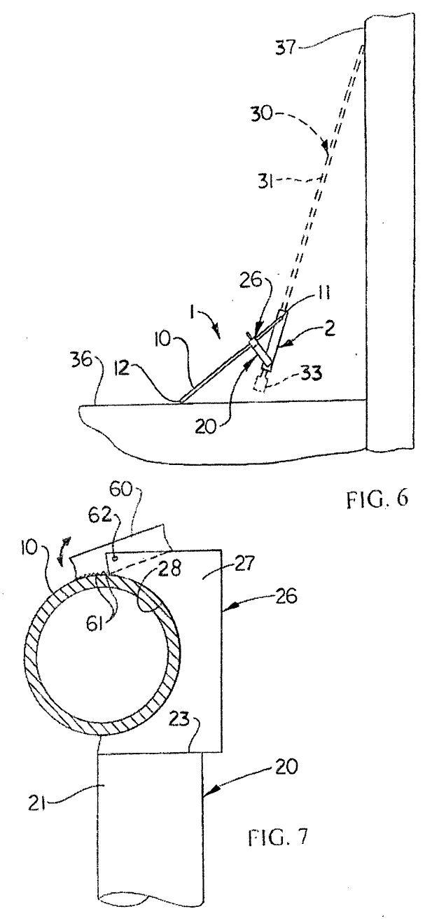

In typical application of the extension ladder stabilizer 1, the ladder feet 33 of the extension ladder 30 do not rest on a supporting surface 36 such as the ground or a floor, for example. The upper ends of the ladder frame members 31 rest against the wall 37 (FIGS. 5 and 6). When its use is not desired, the extension ladder stabilizer 1 can be selectively deployed in the non-functional or storage position illustrated in FIGS. 1 and 5 by pivoting and rotating the stabilizing legs 10 to the upwardly-extended configuration and pivoting and rotating the leg braces 20 to the downwardly-extended configuration.

The extension ladder stabilizer 1 can be selectively deployed in the functional, ladder-stabilizing position illustrated in FIGS. 2 and 6 by pivoting and rotating the stabilizing legs 10 to the downwardly-extended configuration such that the distal leg ends 12 of the respective stabilizing legs 10 rest on the support surface 36. The ladder feet 33 of the extension ladder 30 are typically suspended above the support surface 36. As illustrated in FIG. 6, the longitudinal axis of each stabilizing leg 10 is oriented at a generally obtuse angle with respect to the longitudinal axis of each ladder mount member 2. The leg braces 20 are pivoted and rotated to the upwardly-extended configuration and the leg receptacle cavity 28 (FIG. 7) of each leg receptacle 26 receives the corresponding stabilizing leg 10. As illustrated in FIG. 7, using any suitable technique which is known by those skilled in the art, a leg clasping mechanism grasps the stabilizing leg 10 to secure the stabilizing leg 10 in the leg receptacle cavity 28. In some embodiments, the leg clasping mechanism includes the leg gripping member 60 which is pivotally attached to the leg receptacle body 27 via the pivot pin 62. The gripping teeth 61 engage the exterior surface of the stabilizing leg 10 to secure the stabilizing leg 10 in the leg receptacle cavity 28. As illustrated in FIG. 6, the longitudinal axis of each leg brace 20 is oriented in generally perpendicular relationship with respect to the longitudinal axis of the corresponding stabilizing leg 10. The stabilizing legs 10 stabilize the extension ladder 30 in the upright position and prevent or reduce the tendency of the extension ladder 30 to sway or fall to the left or right in the event that a user (not illustrated) reaches to the left or right of the extension ladder 30 while standing on the extension ladder 30. Moreover, the stabilizing legs 10 prevent or reduce the possibility that the extension ladder 30 will fall backwards as the user initially grasps and begins to ascend or as the user descends the extension ladder 30. The extension ladder stabilizer 1 can be selectively returned to the non-functional, storage position illustrated in FIGS. 1 and 5 by removing the stabilizer legs 10 from the leg receptacle cavities 28 (FIG. 7) of the respective leg receptacles 26 and pivoting and rotating the stabilizer legs 10 back to the upwardly-extending positions and the leg braces 20 back to the downwardly-extending positions. In some embodiments, each stabilizing leg 10 may be height-adjustable, such as through a telescoping or other extendable configuration, for example, to compensate for an uneven support surface 36.

While the preferred embodiments of the disclosure have been described above, it will be recognized and understood that various modifications can be made in the disclosure and the appended claims are intended to cover all such modifications which may fall within the spirit and scope of the disclosure.

I claim:

1. An extension ladder stabilizer, comprising:
a pair of generally elongated, spaced-apart ladder mount members;
a pair of generally elongated stabilizer legs swivelly carried by the pair of ladder mount members, respectively;
a pair of leg braces having a pair of leg receptacles, respectively, swivelly carried by the pair of ladder mount members, respectively; and
wherein the pair of leg receptacles is adapted to removably receive the pair of stabilizer legs, respectively.

2. The extension ladder stabilizer of claim 1 wherein each of the pair of leg receptacles comprises a leg receptacle body and a leg receptacle cavity provided in the leg receptacle body and adapted to removably receive a corresponding one of the pair of stabilizer legs.

3. The extension ladder stabilizer of claim 2 further comprising a leg clasping mechanism carried by the leg receptacle body.

4. The extension ladder stabilizer of claim 3 wherein the leg clasping mechanism comprises a leg gripping member having a plurality of gripping teeth pivotally carried by the leg receptacle body.

5. The extension ladder stabilizer of claim 1 further comprising a first pair of swivel brackets carried by the pair of ladder mount members, respectively, and wherein the pair of stabilizer legs is carried by the first pair of swivel brackets, respectively.

6. The extension ladder stabilizer of claim 5 further comprising a second pair of swivel brackets carried by the pair of ladder mount members, respectively, and wherein the pair of leg braces is carried by the second pair of swivel brackets, respectively.

7. The extension ladder of claim 6 wherein each of the first pair of swivel brackets and each of the second pair of swivel brackets comprises a base plate carried by a corresponding one of the pair of ladder mount members, a bracket body rotatably carried by the base plate and a pair of bracket flanges extending from the bracket body and wherein each of the pair of stabilizer legs and each of the pair of leg braces is pivotally attached to the pair of bracket flanges of the corresponding one of the first pair of swivel brackets and the second pair of swivel brackets.

8. The extension ladder stabilizer of claim 1 further comprising at least two attachment devices attaching the pair of ladder mount members to each other.

9. An extension ladder stabilizer, comprising:
a pair of generally elongated, parallel, spaced-apart ladder mount members having at least two pairs of bolt openings, respectively;
a first pair of swivel brackets carried by the pair of ladder mount members, respectively;
a pair of generally elongated stabilizer legs having a pair of proximal leg ends carried by the first pair of swivel brackets, respectively, and a pair of distal leg ends opposite the pair of proximal leg ends, respectively;
a second pair of swivel brackets carried by the pair of ladder mount members, respectively;
a pair of leg braces including a pair of leg brace shafts having a pair of proximal shaft ends carried by the second pair of swivel brackets, respectively, and a pair of distal shaft ends opposite the pair of proximal shaft ends, respectively, and a pair of leg receptacles provided on the pair of distal shaft ends, respectively, of the pair of leg brace shafts;
wherein the pair of leg receptacles is adapted to removably receive the pair of stabilizer legs, respectively; and
at least two attachment devices attaching the pair of ladder mount members to each other and comprising a pair of device frame plates extending between the pair of ladder mount members and a pair of threaded rods threadably engaging the pair of device frame plates and extending through the at least two pairs of bolt openings, respectively, in the pair of ladder mount members.

10. The extension ladder stabilizer of claim 9 wherein each of the pair of leg receptacles comprises a leg receptacle body and a leg receptacle cavity provided in the leg receptacle body and adapted to removably receive a corresponding one of the stabilizer legs.

11. The extension ladder stabilizer of claim 10 further comprising leg clasping mechanism carried by the leg receptacle body.

12. The extension ladder stabilizer of claim 11 wherein the leg clasping mechanism comprises a leg gripping member having a plurality of gripping teeth pivotally carried by the leg receptacle body.

13. The extension ladder stabilizer of claim 9 wherein each of the first pair of swivel brackets and each of the second pair of swivel brackets comprises a base plate carried by a corresponding one of the pair of ladder mount members, a bracket body rotatably carried by the base plate and a pair of bracket flanges extending from the bracket body and wherein each of the pair of stabilizer legs and each of the pair of leg braces is pivotally attached to the pair of bracket flanges of the corresponding one of the first pair of swivel brackets and the second pair of swivel brackets.

14. The extension ladder of claim 9 further comprising a pair of resilient spacers provided on the pair of threaded rods, respectively, of the at least two attachment devices and engaging the pair of ladder mount members, respectively.

15. A stabilized extension ladder, comprising:
an extension ladder having a pair of spaced-apart ladder frame members and a plurality of ladder rungs connecting the pair of ladder frame members; and
an extension ladder stabilizer comprising:
a pair of generally elongated, spaced-apart ladder mount members carried by the extension ladder;
a pair of generally elongated stabilizer legs swivelly carried by the pair of ladder mount members, respectively;
a pair of leg braces having a pair of leg receptacles, respectively, swivelly carried by the pair of ladder mount members, respectively; and
wherein the pair of leg receptacles is adapted to removably receive the pair of stabilizer legs, respectively.

16. The stabilized extension ladder of claim 15 wherein each of the pair of leg receptacles comprises a leg receptacle body and a leg receptacle cavity provided in the leg receptacle body and adapted to removably receive a corresponding one of the stabilizer legs, and a clamping mechanism carried by the leg receptacle body.

17. The extension ladder stabilizer of claim 15 further comprising a first pair of swivel brackets carried by the pair of ladder mount members, respectively; wherein the pair of stabilizer legs is carried by the first pair of swivel brackets, respectively; and further comprising a second pair of swivel brackets carried by the pair of ladder mount members, respectively; and wherein the pair of leg braces is carried by the second pair of swivel brackets, respectively.

18. The extension ladder of claim 17 wherein each of the first pair of swivel brackets and each of the second pair of swivel brackets comprises a base plate carried by a corresponding one of the pair of ladder mount members; a bracket body rotatably carried by the base plate; and a pair of bracket flanges extending from the bracket body, and wherein each of the pair of stabilizer legs and each of the pair of leg braces is pivotally attached to the pair of bracket flanges of the corresponding one of the first pair of swivel brackets and the second pair of swivel brackets.

19. The extension ladder stabilizer of claim 15 further comprising at least two attachment devices attaching the pair of ladder mount members to each other.

20. The extension ladder stabilizer of claim 19 wherein the at least two attachment devices each comprises a pair of device frame plates extending through at least one of the ladder rungs of the extension ladder and between the pair of ladder mount members and a pair of bolts threadably engaging the pair of device frame plates and extending through the at least one pair of bolt openings, respectively, in the pair of ladder mount members and a pair of resilient spacers provided on the pair of bolts and interposed between the extension ladder and the pair of ladder mount members, respectively.
